(19) United States
(12) Patent Application Publication
(10) Pub. No.: US 2008/0303822 A1
(43) Pub. Date: Dec. 11, 2008

(54) Font metadata

(76) Inventors: Nathan Daniel Taylor, Scotts Valley, CA (US); Peter Giles Lofting, San Jose, CA (US); Julio Amable Gonzalez, San Jose, CA (US); Giulia Pereyra Pagallo, Cupertino, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 11/904,781

(22) Filed: Sep. 28, 2007

Related U.S. Application Data
(60) Provisional application No. 60/943,045, filed on Jun. 9, 2007.

(51) Int. Cl. G06T 11/00

(52) U.S. Cl. 345/467

(57) ABSTRACT

A method and an apparatus for deriving one or more selection criteria to select one or more fonts to present character data in an electronic document are described. The selection criteria may be applied on font metadata to select the fonts. An available font may be determined in place of a selected but unavailable font based on font metadata.

### CROSS-REFERENCE TO RELATED APPLICATIONS

This application is related to, and claims the benefits of, U.S. Provisional Patent Application No. 60/943,045, filed on Jun. 9, 2007 entitled “META DATA BASED FONT SELECTION,” Julio Gonzalez et al. which is hereby incorporated herein by reference.

### FIELD OF INVENTION

The present invention relates generally to presenting document text. More particularly, this invention relates to handling font metadata.

### BACKGROUND

When a document's text is to be displayed visually, characters are mapped to glyphs in a font. A glyph is the actual artistic representation of an abstract glyph, in some typographic style, in the form of outlines or bitmaps that may be drawn on the screen or paper. Typically, the set of glyphs in a font observe similar attributes, such as design, size, appearance, etc. However, such attributes are mostly implicitly hidden inside glyphs in font data. As such, they are rarely applicable when selecting a font.

Furthermore, additional information produced from font data, such as derived from human knowledge about how a particular font or a set of fonts should be used is completely missing from typical fonts. For example, a font may be designed for an English user but not for a Chinese user, even though a common character presentable with the font may appear in both an English document and a Chinese document. In addition, a collection of fonts intended for writing letters may not be proper for writing business contracts. However, such critical information in determining which font to use is usually not present in font data associated with a font.

As a result, existing font systems are ineffective in providing sufficient information for handling fonts.

### SUMMARY OF THE DESCRIPTION

An embodiment of the present invention includes a method and apparatus that derive one or more selection criteria to select one or more fonts for presenting character data in an electronic document. The selection criteria may be applied on font metadata to select the fonts. An available font may be determined in place of a selected but unavailable font based on font metadata.

Other features of the present invention will be apparent from the accompanying drawings and from the detailed description that follows.

### BRIEF DESCRIPTION OF THE DRAWINGS

FIG. 1 is a block diagram illustrating one embodiment of a system to select fonts based on font metadata;

FIG. 2 is a flow diagram illustrating one embodiment of a process to select fonts based on font metadata;

FIG. 3A is a flow diagram illustrating one embodiment of a process to present a list of fonts based on font metadata;

FIG. 3B is a block diagram illustrating one embodiment of a system to present a list of fonts based on font metadata;

FIG. 4 illustrates one example of a typical computer system which may be used in conjunction with the embodiments described herein.

### DETAILED DESCRIPTIONS

A method and an apparatus for metadata based font processing are described herein. In the following description, numerous specific details are set forth to provide thorough explanation of embodiments of the present invention. It will be apparent, however, to one skilled in the art, that embodiments of the present invention may be practiced without these specific details. In other instances, well-known components, structures, and techniques have not been shown in detail in order not to obscure the understanding of this description

Reference in the specification to “one embodiment” or “an embodiment” means that a particular feature, structure, or characteristic described in connection with the embodiment can be included in at least one embodiment of the invention. The appearances of the phrase “in one embodiment” in various places in the specification do not necessarily all refer to the same embodiment.

The processes depicted in the figures that follow, are performed by processing logic that comprises hardware (e.g., circuitry, dedicated logic, etc.), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

The term “host” and the term “device” are intended to refer generally to data processing systems rather than specifically to a particular form factor for the host versus a form factor for the device.

In one embodiment, font metadata may add information to a font to facilitate font selection. Font metadata may be based on human knowledge for representing, for example, what an associated font is designed for or intended to be used. A unified scale according to human perception may be applied to font metadata. In one embodiment, font metadata may enable measuring similarity between separate fonts closely approximating how a user would perceive. An automatic font selection and/or substitution may be made possible via similarity measurement based on font metadata. In one embodiment, a collection of fonts making sense to a user may be determined according to font metadata. A list of fonts presented to a user for selection may be pre screened from all available fonts according to font metadata, such as, for example, a list of heading fonts similar to a heading font specified in a document template.

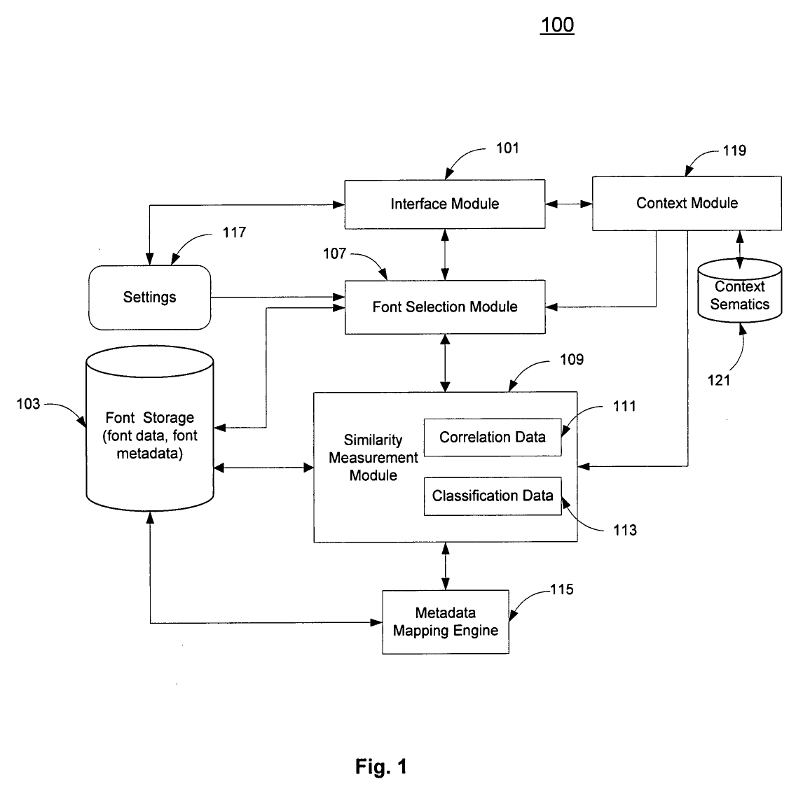

FIG. 1 is a block diagram illustrating one embodiment of a system to select fonts based on font metadata. System 100 may belong to an operating environment (e.g. operating system) in a computer system. In one embodiment, system 100 may include a font storage 103 in which font data and font metadata may be stored. A font storage may include a database with font entries. A font storage may include font metadata associated with font entries. A font data may be a font file including information on how to represent data characters and display glyphs. In one embodiment, font metadata may be information based on human knowledge about an associated font, such as cultural references or ratings elicited from psychometric testing. Font metadata may be attached to an original font data file or in a separate font metadata file in font storage 103. A font storage 103 may store font metadata without storing corresponding font data.

In one embodiment, font metadata may include subjective and/or objective measurements of font attributes, such as a level of boldness, a scale of italic angle, whether a font is a mono space font, whether a font is a cursive font, whether a font is a serif font, a weight measure, a measure of width compression, the target group of users (e.g. English users), the thickness of strokes, an aspect ratio, and/or a level of ornamentation, etc. An attribute for font metadata may be associated with a value (e.g. Boolean, real value, integer value, strings etc.). For example, font metadata for Lucida Grande may include an attribute with a string value including “English” specifying English users as one of a target group of users for Lucida Grande font. In one embodiment, an attribute may be associated with a usage type for a corresponding font, e.g. whether it is a picture font, an artistic font, a fancy font, a font used for writing, a graphic arts font, or a math font etc. An attribute associated with objective measurements may be based on statistically collected levels of similarities among different fonts. In an aspect, metadata may be direct measures or may be measures derived from analysis and processing of statistical measures from psychometric testing of one or many different representative groups of people. In various aspects, font metadata may be used to sort a set of fonts, filter out a certain group of fonts, search for a particular font, or arrange a list of fonts to present to a user, etc. Font metadata may also be used in video for selecting preferential display, e.g. bitmap vs. vector, or for conformance to CCTV close caption standards.

In one embodiment, a context module 119 may determine a context for a document. A context may be related to a type of a document. For example, a business letter may belong to a different context as a document than a wedding invitation. In another embodiment, a context may include selected fonts and/or styles associated with a portion of character data in a document, such as, for example, multiple scripts intermixed within a line, a paragraph or a page of text. In another embodiment, a context may include predetermined relationships and/or constraints on font metadata associated with different parts of a document, such as, for example, type settings for headline text and body text in a document template for business contract. In one embodiment, a context module 119 may include semantic evaluation to automatically determine a context for a document. For example, a semantic evaluation may determine whether a user is working on a business letter or a wedding invitation. Semantic evaluation may be based on mapping semantic data to contexts according to predetermined relationships between document semantics and contexts. Additionally, a context module 119 may determine a context according to a user setting or existing font settings in a document.

In one embodiment, a font selection module 107 may receive a font request for one or more fonts from an interface module 101. An interface module 101 may be associated with a user interface. In one embodiment, an interface module 101 may be directly or indirectly coupled to an Application Programming Interface. A font selection module 107 may determine font selection criteria directly or indirectly from a received font request. In one embodiment, a font selection module 107 may derive selection criteria based on a document context from a context module 119 and/or a system setting stored in settings 117. A system setting may be applicable by default to multiple documents in a system, such as, for example, specifying a default language setting, e.g. “English”, for default font selection.

In one embodiment, a font selection module 107 may select a font from among a plurality of fonts stored in a font storage 103 according to selection criteria determined from a received font request, a context from a context module 119 and/or a system setting from settings 117. A font selection module 107 may match font metadata stored in a font storage 103 against selection criteria. A font may be unavailable if the corresponding font data are not present in a font storage 103. Font metadata for an unavailable font may be available in a font storage 103. If a font associated with matched font metadata is not available in a font storage 103, in one embodiment, a font selection module 107 may select similar fonts from available fonts in a font storage 103 according to similarity measurements in a similarity measurement module 109.

A similarity measurement module 109 may compute a similarity measure (e.g. a number to indicate level of similarity) between two separate fonts based on font metadata. In one embodiment, a similarity measurement module 109 may include correlation data 111 and/or classification data 113. Correlation data 111 may include, for example, statistics correlation relationships between separate fonts according to font metadata. Classification data 113 may include, for example, hierarchical tree-like grouping relationships among multiple fonts according to font metadata. Fonts may be grouped according to scripts, such as Latin script or Han Ideographic script. In one embodiment, a similarity measurement module 109 may perform attribute mapping through a metadata mapping engine 115 to transform one or more metadata attribute values for similarity measurement. Transformed metadata from a metadata mapping engine 115 may include a smaller or larger number of attributes than the original metadata. A similarity measurement module 109 may determine a similarity for a font according to one or more metadata values based on a correlation data 111, a classification data 113 and/or transformed metadata from a metadata mapping engine 115.

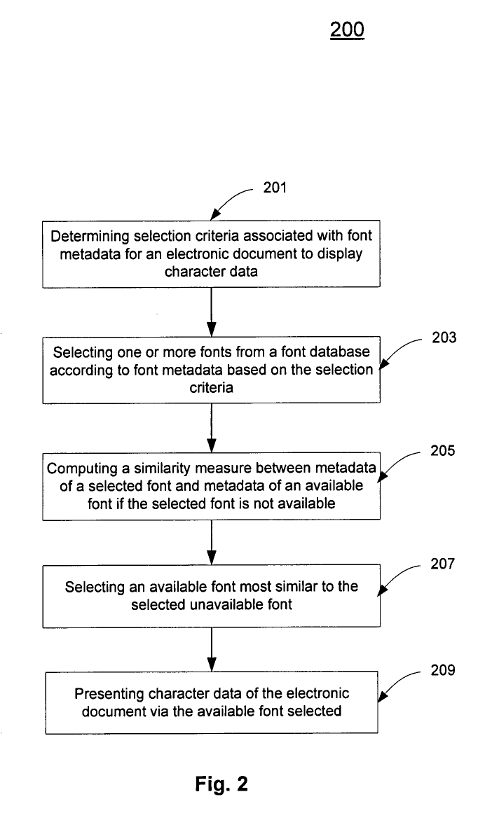

FIG. 2 is a flow diagram illustrating one embodiment of a process 200 to select fonts based on font metadata. Process 200 may be performed, for example, by system 100 of FIG. 1. At block 201, in one embodiment, the processing logic of process 200 may determine selection criteria to select a font for displaying character data in an electronic document based on font metadata. Selection criteria may be related to, for example, a collection of fonts targeting English users, one or more fonts bolder than a specified font identified by a font name, or a set of contrasting, yet complimentary fonts for use together in a particular context, such as a headline font and a body text font for a newsletter document. In one embodiment, selection criteria may include constraints about attribute values for font metadata. A constraint may be associated with one or more values or range of values for one or more attributes of font metadata. In one embodiment, a constraint may include relationships between font metadata from separate fonts.

The processing logic of process 200 may derive selection criteria according to a font request, system settings, e.g. settings 117 of FIG. 1, and/or a document context, e.g. a context from context module 119 of FIG. 1. In one embodiment, a font request may be generated for displaying a font list menu. In another embodiment, a font request may be based on user input to select a list of fonts, for example, a list of fonts suitable for typesetting a contract document. A system may generate a font request for selecting a certain font to present character data for a document. In one embodiment, a system may request a font which may or may not be available in the system, e.g. not stored in a storage of the system, such as font storage 103 of FIG. 1, of the system. Selection criteria based on font metadata may be directly associated with a font request, such as, for example, boldness level above a certain value. In one embodiment, the processing logic of process 200 may derive selection criteria on a font usage type based on a context. For example, selection criteria may be derived to match fancy fonts with a wedding invitation (a context). A fancy font may be characterized by a font metadata value. The processing logic of process 200 may determine selection criteria according to current system settings, e.g. a particular font language. In one embodiment, the processing logic of process 200 may resolve conflicting selection criteria derived from a font request, a system setting and/or a context. For example, the processing logic of process 200 may assign higher priority to selection criteria derived from a context than those from a system setting.

At block 203, in one embodiment, the processing logic of process 200 may select one or more fonts according to selection criteria derived at block 201 and font metadata stored in a system. A selected font may be associated with font metadata matching selection criteria. A selected font may be unavailable if the corresponding font data are not stored in a system, such as in a font storage 103 of FIG. 1. If more than one fonts are associated with matched font metadata, the processing logic of process 200 may randomly select one of the fonts with matched metadata. In one embodiment, the processing logic of process 200 may determine a level of similarity for the fonts with matched metadata against, for example, one or more current fonts associated with a context of a document. Selected fonts may be ranked according to levels of similarity. In one embodiment, a level of similarity may be measured according to correlation data and classification data on font metadata, such as in similarity measurement module 109 of FIG. 1. Selecting one of the fonts associated with matching font metadata may be based on a ranked similarity levels or in a random manner.

In one embodiment, at block 205, when a selected font at block 203 is not available, the processing logic of process 200 may compute a similarity measure between the unavailable selected font with an available font from a font storage, such as font storage 103 of FIG. 1. A similarity measure may be based on font metadata, such as in similarity measure module 109 of FIG. 1. At block 207, the processing logic of process 200 may substitute an unavailable font with an available font most similar to the unavailable font based on similarity measures at block 205. The processing logic of process 200 may present character data of a document at block 209 with font data associated with an available font most similar to an unavailable font with matched font metadata according to font selection at block 207.

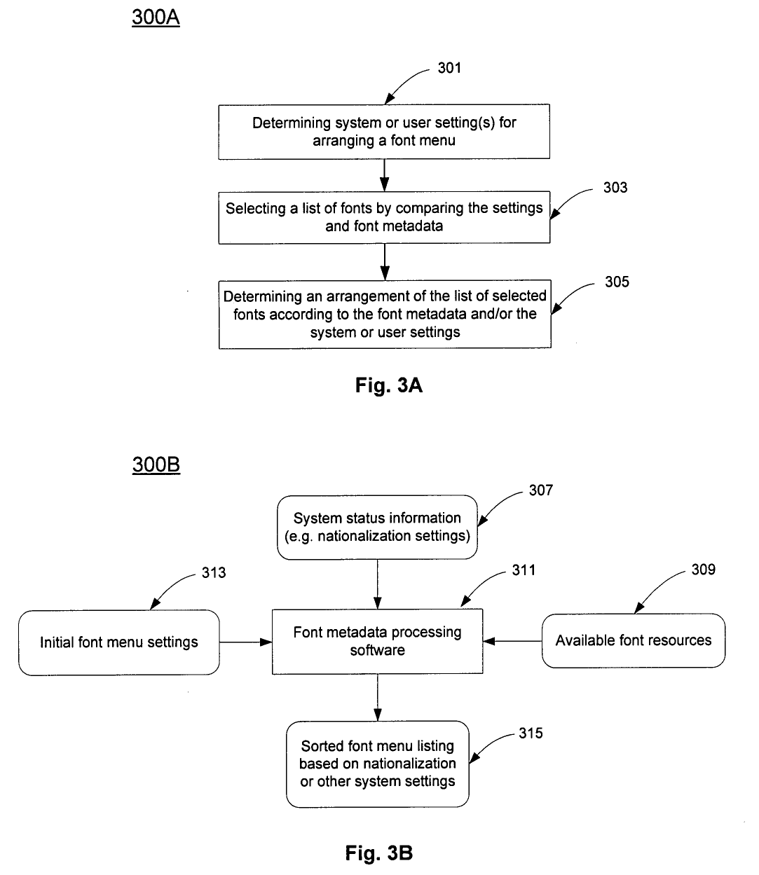

FIG. 3A is a flow diagram illustrating one embodiment of a process to select fonts based on font metadata. Process 300A may be performed, for example, by system 100 of FIG. 1. In one embodiment, the processing logic of process 200 may determine a system or user settings for arranging a font menu at block 301. A font menu may be, for example, arranged for a user to select a font according to a document template. A setting may include a default or a user specified language name, such as “English”. At block 303, the processing logic of process 300A may select a list of fonts by comparing the settings with font metadata from a plurality of fonts. In one embodiment, font metadata compared at block 303 may be associated with fonts already registered in the system, such as stored in font storage 103 of FIG. 1. The list of selected fonts at block 303 may be based on font metadata satisfying the settings of block 301. At block 305, the processing logic of process 300A may determine an arrangement for the selected list of fonts according to font metadata and/or system or user settings. In one embodiment, the processing logic of process 300A may sort the list of selected fonts according to a similarity measurement between font metadata associated with the selected fonts and a predetermined attribute or a reference font. In another embodiment, an arrangement of a list of selected fonts may be based on an alphabetic order. A list of fonts may be selected according to a user or system setting, such as a specific language and/or an internationalization specification for a nation or region.

FIG. 3B is a block diagram illustrating one embodiment of a system to present a list of fonts based on font metadata. System 300B may perform process 300A of FIG. 3A. In one embodiment, font metadata processing software 311 may retrieve settings from system status information 307 and/or initial font menu settings 313, included in, for example, settings 117 of FIG. 1. System status information 307 may include a nationalization or internationalization setting specifying, for example, a system version to be used in a country (e.g. “Canada”). Initial font menu setting 313 may include a set of default fonts to be presented via a font menu. In one embodiment, font metadata processing software 311 may be part of Font Selection Module 107 of FIG. 1. Based on system settings 307 and/or initial settings 313, font metadata processing software 311 may generate a sorted font menu listing 315 according to information obtained from available font resources 309, such as in Font Storage 103 of FIG. 1. In one embodiment, a font menu list may be sorted according to a nationalization setting which assigns higher priority to an available font designated for a nation or a region as specified in system status information 307.

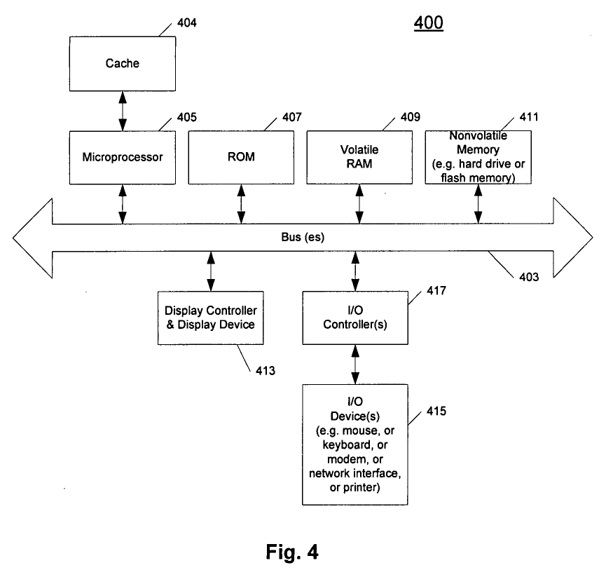

FIG. 4 shows one example of a data processing system such as a computer system, which may be used with one embodiment of the present invention. For example, the system 400 may be implemented as a part of the system shown in FIGS. 1. Note that while FIG. 4 illustrates various components of a computer system, it is not intended to represent any particular architecture or manner of interconnecting the components as such details are not germane to the present invention. It will also be appreciated that network computers and other data processing systems which have fewer components or perhaps more components may also be used with the present invention.

As shown in FIG. 4, the computer system 401, which is a form of a data processing system, includes a bus 403 which is coupled to a microprocessor(s) 405 and a ROM (Read Only Memory) 407 and volatile RAM 409 and a non-volatile memory 411. The microprocessor 403 may retrieve the instructions from the memories 407, 409, 411 and execute the instructions to perform operations described above. The bus 403 interconnects these various components together and also interconnects these components 405, 407, 409, and 411 to a display controller and display device 413 and to peripheral devices such as input/output (I/O) devices which may be mice, keyboards, modems, network interfaces, printers and other devices which are well known in the art. Typically, the input/output devices 415 are coupled to the system through input/output controllers 417. The volatile RAM (Random Access Memory) 409 is typically implemented as dynamic RAM (DRAM) which requires power continually in order to refresh or maintain the data in the memory.

The mass storage 411 is typically a magnetic hard drive or a magnetic optical drive or an optical drive or a DVD RAM or a flash memory or other types of memory systems which maintain data (e.g. large amounts of data) even after power is removed from the system. Typically, the mass storage 411 will also be a random access memory although this is not required. While FIG. 4 shows that the mass storage 411 is a local device coupled directly to the rest of the components in the data processing system, it will be appreciated that the present invention may utilize a non-volatile memory which is remote from the system, such as a network storage device which is coupled to the data processing system through a network interface such as a modem or Ethernet interface or wireless networking interface. The bus 403 may include one or more buses connected to each other through various bridges, controllers and/or adapters as is well known in the art.

Portions of what was described above may be implemented with logic circuitry such as a dedicated logic circuit or with a microcontroller or other form of processing core that executes program code instructions. Thus processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations described herein. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMs, EPROMs, EEPROMs, magnetic or optical cards, or any type of media suitable for storing electronic instructions, and each coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will be evident from the description below. In addition, the present invention is not described with reference to any particular programming language. It will be appreciated that a variety of programming languages may be used to implement the teachings of the invention as described herein. The foregoing discussion merely describes some exemplary embodiments of the present invention. One skilled in the art will readily recognize from such discussion, the accompanying drawings and the claims that various modifications can be made without departing from the spirit and scope of the invention.

What is claimed is:

1. A computer-implemented method, the method comprising:
deriving one or more selection criteria based on font metadata for an electronic document having character data;
selecting one or more fonts according to the one or more selection criteria; and
determining an available font based on the one or more fonts to display the character data.

2. The method of claim 1, wherein the one or more selection criteria include relationships among metadata from separate fonts.

3. The method of claim 2, wherein the one or more selection criteria are associated with a context of the electronic document and wherein the derivation of the one or more selection criteria comprises:
performing a semantic evaluation on the document to determine the context; and
retrieving one or more templates for the context, the relationships being defined according to the one or more templates.

4. The method of claim 1, wherein the one or more selection criteria include a range of matching values for the font metadata.

5. The method of claim 4, wherein the matching values are associated with a language setting.

6. The method of claim 5, wherein the range of values are associated with boldness of the one or more fonts.

7. The method of claim 1, wherein the selecting the one or more fonts comprises:
presenting the one or more fonts via a user interface menu in a an order sorted based on the font metadata.

8. The method of claim 1, wherein the determining the available font comprises:
computing a similarity measure between metadata of the available font and meta data of an unavailable font, the one or more fonts including the unavailable font; and
comparing similarity measures associated with the metadata of the unavailable font, the similarity measures including the similarity measure.

9. The method of claim 8, wherein the similarity measure is based on a correlation data between the available font and the unavailable font.

10. A machine-readable medium having instructions stored therein, which when executed by a machine, cause a machine to perform a method, the method comprising:
deriving one or more selection criteria based on font metadata for an electronic document having character data;
selecting one or more fonts according to the one or more selection criteria; and
determining an available font based on the one or more fonts to display the character data.

11. The machine-readable medium of claim 10, wherein the one or more selection criteria include relationships among metadata from separate fonts.

12. The machine-readable medium of claim 11, wherein the one or more selection criteria are associated with a context of the electronic document and wherein the derivation of the one or more selection criteria comprises:
performing a semantic evaluation on the document to determine the context; and
retrieving one or more templates for the context, the relationships being defined according to the one or more templates.

13. The machine-readable medium of claim 10, wherein the one or more selection criteria include a range of matching values for the font metadata.

14. The machine-readable medium of claim 13, wherein the matching values are associated with a language setting.

15. The machine-readable medium of claim 14, wherein the range of values are associated with boldness of the one or more fonts.

16. The machine-readable medium of claim 10, wherein the selecting the one or more fonts comprises:
presenting the one or more fonts via a user interface menu in an order sorted based on the font metadata.

17. The machine-readable medium of claim 10, wherein the determining the available font comprises:
computing a similarity measure between metadata of the available font and meta data of an unavailable font, the one or more fonts including the unavailable font; and
comparing similarity measures associated with the metadata of the unavailable font, the similarity measures including the similarity measure.

18. The machine-readable medium of claim 17, wherein the similarity measure is based on a correlation data between the available font and the unavailable font.

19. A data processing system comprising:
means for deriving one or more selection criteria on font metadata for an electronic document having character data;
means for selecting one or more fonts according to the one or more selection criteria; and
means for determining an available font based on the one or more fonts to display the character data.

20. A machine-readable medium having instructions stored therein, which when executed by a machine, cause a machine to perform a method, the method comprising:
determining settings for a font menu associated with fonts having font metadata;
comparing the settings and the font metadata; and
arranging the font menu according to the comparison.

21. The machine-readable medium of claim 20, wherein the arranging the font menu comprises:
selecting one or more fonts from the fonts; and
sorting the one or more fonts in an order according to the settings.
